(19) United States
(12) Patent Application Publication
(10) Pub. No.: US 2014/0298347 A1
(43) Pub. Date: Oct. 2, 2014

(54) COMPUTING SYSTEM WITH RESOURCE MANAGEMENT MECHANISM AND METHOD OF OPERATION THEREOF

(71) Applicant: Samsung Electronics Co., Ltd., Gyeonggi-Do (KR)

(72) Inventors: William Aylesworth, Santa Clara, CA (US); Chunkwok Lee, Santa Clara, CA (US); Jeffrey Scott Pierce, Sunnyvale, CA (US); Alan John Walendowski, San Jose, CA (US)

(73) Assignee: Samsung Electronics Co., Ltd., Gyeonggi-Do (KR)

(21) Appl. No.: 14/041,057

(22) Filed: Sep. 30, 2013

Related U.S. Application Data
(60) Provisional application No. 61/780,071, filed on Mar. 13, 2013.

(51) Int. Cl. G06F 9/50

(52) U.S. Cl. CPC G06F 9/5005
USPC 718/104

(57) ABSTRACT

A computing system includes: an activity-schedule module configured to identify a future activity estimation for representing an activity occurring after a current time; a usage module, coupled to the activity-schedule module, configured to generate a consumption model associated with the future activity estimation for describing a resource; a model generator module, coupled to the usage module, configured to determine a cost model for evaluating an access location; and a selection module, coupled to the model generator module, configured to determine an optimal access selection based on the cost model and the consumption model for displaying on a device.

### TECHNICAL FIELD

An embodiment of the present invention relates generally to a computing system, and more particularly to a system for managing resources.

### BACKGROUND

Modern consumer and industrial electronics, such as computing systems, televisions, tablets, cellular phones, portable digital assistants, projectors, and combination devices, are providing increasing levels of functionality to support modern life. In addition to the explosion of functionality and proliferation of these devices into the everyday life, there is also an explosion of data and information being created, transported, consumed, and stored.

The increasing demand for information in modern life requires users to access information at any time, for longer periods of time, and more frequently throughout their day. The increased usage creates heavier demand on limited resources available to the user.

Thus, a need still remains for a computing system with resource management mechanism for optimizing the user of resources available to the user. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides a computing system, including: an activity-schedule module configured to identify a future activity estimation for representing an activity occurring after a current time; a usage module, coupled to the activity-schedule module, configured to generate a consumption model associated with the future activity estimation for describing a resource; a model generator module, coupled to the usage module, configured to determine a cost model for evaluating an access location; and a selection module, coupled to the model generator module, configured to determine an optimal access selection based on the cost model and the consumption model for displaying on a device.

An embodiment of the present invention provides a method of operation of a computing system including: identifying a future activity estimation for representing an activity occurring after a current time; generating a consumption model associated with the future activity estimation for describing a resource; determining a cost model for evaluating an access location; and determining an optimal access selection based on the cost model and the consumption model for displaying on a device.

An embodiment of the present invention provides a non-transitory computer readable medium having instructions including: identifying a future activity estimation for representing an activity occurring after a current time; generating a consumption model associated with the future activity estimation for describing a resource; determining a cost model for evaluating an access location; and determining an optimal access selection based on the cost model and the consumption model for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computing system with configuration update mechanism in an embodiment of the present invention.

FIG. 2 is an example display of the first device.

FIG. 3 is a further example display of the first device.

FIG. 4 is a functional block diagram of the computing system.

FIG. 5 is a control flow of the computing system.

FIG. 6 is a flow chart of a method of operation of a computing system in a further embodiment of the present invention.

### DETAILED DESCRIPTION

An embodiment of the present invention determines an optimal access selection for a user to access a resource given a context, an activity, or a combination thereof for a current time, a future time, or a combination thereof. The optimal access selection can be based on a consumption model for estimating a projected usage of the resource given various instances of the activity, the context, or a combination thereof upcoming for the user. The optimal access selection can further be based on evaluating an access location with an access type, a source attribute, or a combination thereof according to a cost model for representing an importance or an appropriateness of various factors according to the context, the activity, or a combination thereof.

For example, the optimal access selection can be determined and communicated to the user when the consumption model indicates that the resource may be insufficient or unavailable for a future activity estimation or a future context. The optimal access selection can be communicated with a resource planning content, which can include other content for facilitating access to the optimal access selection, such as an access-route or a schedule adjustment.

An embodiment of the present invention includes the cost model having a cost-category for evaluating a security factor, a privacy factor, an efficiency factor, a cost factor, or a combination thereof that provides a method of evaluating abstract factors having importance to the user. Further the cost model based on the activity, the context, the consumption model, or a combination thereof provides a contextually relevant evaluation for the access location.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. The software can also include a function, a call to a function, a code block, or a combination thereof. Also for example, the hardware can be circuitry, processor, computer, integrated circuit, integrated circuit cores, a pressure sensor, an inertial sensor, a microelectromechanical system (MEMS), passive devices, physical non-transitory memory medium having instructions for performing the software function, or a combination thereof.

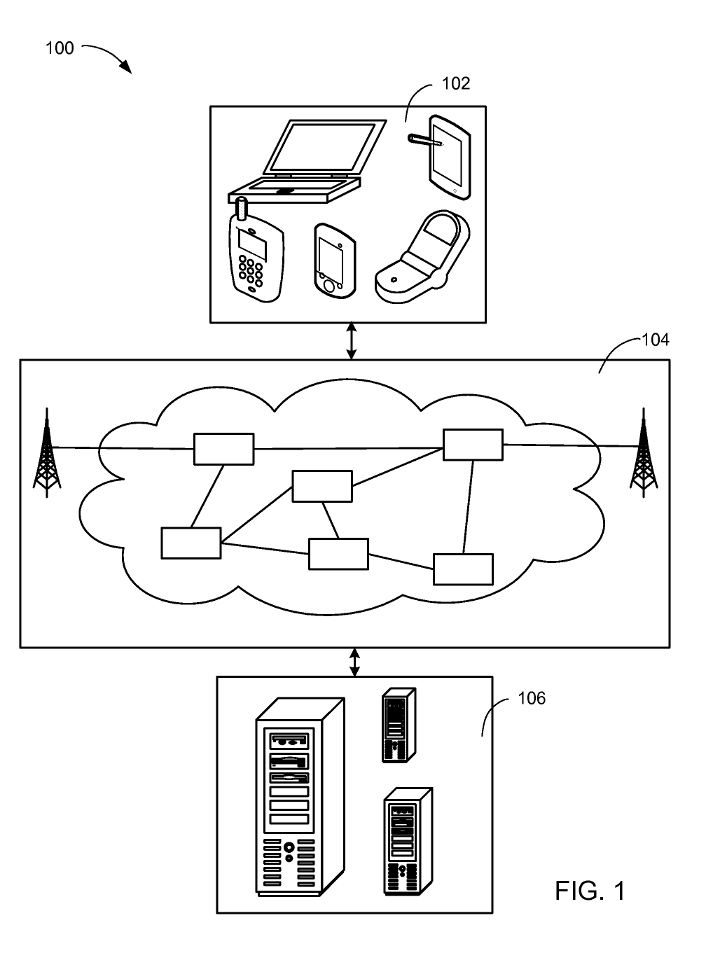

Referring now to FIG. 1, therein is shown a computing system 100 with configuration update mechanism in an embodiment of the present invention. The computing system 100 includes a first device 102, such as a client or a server, connected to a second device 106, such as a client or server, or a combination thereof.

Users of the first device 102, the second device 106, or a combination thereof can communicate with each other or access or create information including text, images, symbols, location information, and audio, as examples. The users can be individuals or enterprise companies. The information can be created directly from a user or operations performed on these information to create more or different information.

The first device 102 can be of any of a variety of devices, such as a smartphone, a cellular phone, personal digital assistant, a tablet computer, a notebook computer, or other multi-functional display or entertainment device. The first device 102 can couple, either directly or indirectly, to the communication path 104 for exchanging information with the second device 106 or each other, or can be a stand-alone device.

For illustrative purposes, the computing system 100 is described with the first device 102 as a portable multi-functional device, although it is understood that the first device 102 can be different types of devices. For example, the first device 102 can also be a workstation or a multi-media presentation. A multi-media presentation can be a presentation including sound, a sequence of streaming images or a video feed, text or a combination thereof.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a recording device, such as a camera or video camera, or a combination thereof. In another example, the second device 106 can be a server at a service provider or a computing device at a transmission facility.

The second device 106 can be centralized in a single room, distributed across different rooms, distributed across different geographical locations, embedded within a telecommunications network. The second device 106 can couple with the communication path 104 to communicate with the first device 102.

For illustrative purposes, the computing system 100 is described with the second device 106 as a computing device, although it is understood that the second device 106 can be different types of devices. Also for illustrative purposes, the computing system 100 is shown with the second device 106 and the first device 102 as end points of the communication path 104, although it is understood that the computing system 100 can have a different partition between the first device 102, the second device 106, and the communication path 104. For example, the first device 102, the second device 106, or a combination thereof can also function as part of the communication path 104.

For further illustrative purposes, the computing system 100 is described with the first device 102 as a consumer device or a portable device, and with the second device 106 as a stationary or an enterprise device. However, it is understood that the first device 102 and the second device 106 can be any variety of devices. For example, the first device 102 can be a stationary device or an enterprise system, such as a television or a server. Also for example, the second device 106 can be a consumer device or a portable device, such as a smart phone or a wearable device.

The communication path 104 can span and represent a variety of network types and network topologies. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

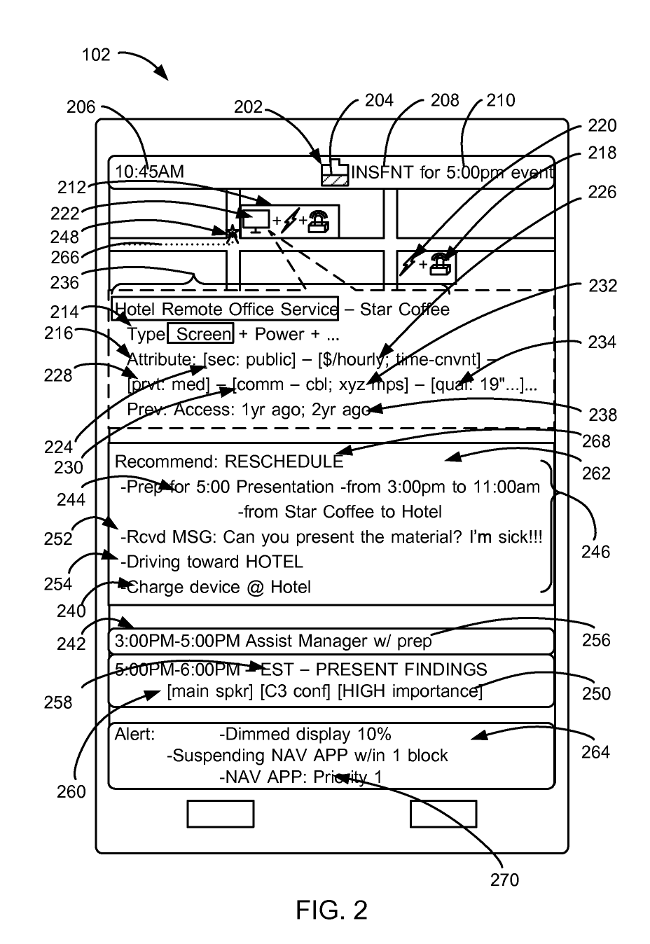

Referring now to FIG. 2, therein is shown an example display of the first device 102. The display can show information regarding a resource 202. The resource 202 is an object, energy, a service, a gateway, or a combination thereof that can be used to perform a function. For example, the resource 202 can include a power source, such as an electrical outlet or a charging device, a network connection, such as a router or a connection port, a peripheral device, or a combination thereof.

The resource 202 can be used to operate or facilitate the first device 102, the second device 106 of FIG. 1, or a combination thereof. For example, the resource 202 can be the energy or the electrical power necessary to operate the first device 102, the second device 106, or a combination thereof. Also for example, the resource 202 can be an access point or a separate device for providing a service or information to the first device 102, the second device 106, or a combination thereof.

The display can show a current resource-status 204 at a current time 206. The current time 206 can include a day of the week, a day of the month, or a combination thereof.

The current resource-status 204 is a representation of the resource 202 relative to the first device 102, the second device 106, or a combination thereof at the current time 206. For example, the current resource-status 204 can include a representation of remaining or accessible power, such as with a relative or arbitrary scale or as an estimation of remaining operation time, availability or connection status for the network 104 of FIG. 1 or a peripheral device, or a combination thereof.

The display can further show a future resource-status 208 at a future time 210. The future resource-status 208 is a representation of the resource 202 relative to the first device 102, the second device 106, or a combination thereof at the future time 210 occurring after the current time 206. For example, the future resource-status 208 can include an estimation or a projection of remaining or accessible power at the future time 210, available access points or peripheral devices at the future time 210, or a combination thereof.

The user can access the resource 202 for the first device 102, the second device 106, or a combination thereof at an access location 212. The access location 212 is a geographical area or an entity, a person, a device, or a combination thereof synonymous with the geographical place having the resource 202 available for access. For example, the access location 212 can be navigational information for a power outlet or a charging device. Also for example, the access location 212 can be a business providing access to the network 104 or the peripheral device.

The access location 212 can include an access type 214, a source attribute 216, or a combination thereof associated therewith. The access type 214 is categorization or identification for the resource 202 available at the access location 212. For example, the access type 214 can include a network access point 218, a charge station 220, a peripheral device site 222, or a combination thereof.

The network access point 218 is an identification or a category for a location where the user can access the network 104. For example, the network access point 218 can be a location where wireless signals for routers are detected or a business offering a specific mode of communicational access, such as LAN or WiFi.

The charge station 220 is an identification or a category for a location where the user can access energy for recharging the first device 102, the second device 106, or a combination thereof. For example, the charge station 220 can be a location including an electrical power source, a power supply, an adapter, a charging device, or a combination thereof accessible to the user. As a more specific example, the charge station 220 can be a business or a service, a public location, a private location, such user's home or a friend's business, or a combination thereof.

The peripheral device site 222 is an identification or a category for a location where the user can access a separate device for use with the first device 102, the second device 106, or a combination thereof. For example, the peripheral device site 222 can be a location including a projector, a printer, a display screen, or a combination thereof. Also for example, the peripheral device site 222 can be a location including the separate device having a management software or an application tool for a function or a feature on the first device 102, the second device 106, or a combination thereof.

The source attribute 216 is a representation of a quality or a characteristic belonging to the access location 212. For example, the source attribute 216 can include a security rating 224, an access cost 226, a privacy rating 228, a communication mode 230 having a communication rate 232, a source quality 234, or a combination thereof.

The security rating 224 is a description of safety associated with the access location 212. The security rating 224 can be a description of safety of the user, user's device, information, or a combination thereof. For example, the security rating 224 can be associated with a potential danger for the user's person or the user's property, including the first device 102, the second device 106, or a combination thereof. As a more specific example, the security rating 224 can be associated with the lighting available at the access location 212, a crime rate or vehicle theft rate for the access location 212, or a combination hereof.

The security rating 224 can further be associated with information. For example, the security rating 224 can be an arbitrary score or rating for protecting access to user's information, such as using membership or password. Also for example, the security rating 224 can be a presence or an absence of information security features, such as encryption or virus protection.

The access cost 226 is an expense to the user required to access the resource 202 at the access location 212. The access cost 226 can be a representation of time, effort, price, or a combination thereof required to access the resource at the access location 212. The access cost 226 can also be a monetary price or a data usage required for accessing the resource at the access location 212.

For example, the access cost 226 can be an estimated amount of time or distance required to travel to the access location 212, use the resource 202, travel from the access location 212 to another location, or a combination thereof. Also for example, the access cost 226 can be the price per unit for the resource 202, the price per unit of time for accessing the resource 202, or a combination thereof at the access location 212.

The privacy rating 228 is a description of exclusivity allowed or facilitated at the access location 212. The privacy rating 228 can be based on separation between the user and other people at the access location 212. For example, the privacy rating 228 can be based on physical separation, such as using a room or a divider, auditory separation or isolation, visual line of sight, or a combination thereof.

As a more specific example, the privacy rating 228 can indicate more privacy, such as by using an arbitrary score or by indicating availability of a feature, for private locations where other users require permission for entering the access location 212. Also as a more specific example, the privacy rating 228 can indicate less privacy for open locations without any physical dividers, without permissions required for accessing the resource 202, such as a password or admission, or a combination thereof.

The communication mode 230 is a method or a way of sharing information between devices. The communication mode 230 can include the communication medium or protocol, a facilitating device or service, or a combination thereof.

For example, the communication mode 230 can include wired or wireless, direct communication between client devices, communication with or through a server, or a combination thereof. As a more specific example, the communication mode 230 can specify WiFi, cable service at home, a specific router or network at work, 4G service, a private server access, or a combination thereof for exchanging information between applicable devices.

The communication rate 232 is a representation of speed for exchanging the information using the corresponding instance of the communication mode 230. The communication rate 232 can include a measured current speed, a projected or estimated speed, a maximum speed, an average speed, or a combination thereof. The communication rate 232 can further include an error rate, a repeat rate, a failure rate, a rate specific to a grouping or a type of data, or a combination thereof

The source quality 234 is an evaluation for a given characteristic for the access location 212. The source quality 234 can be a representation of user's affinity to or a subjective rating for the service or the device for the access location 212. The source quality 234 can further be a specification for the device or the service available at the access location 212.

For example, the source quality 234 can be a number or a capacity, such as in watts or charging speed, of charging devices at the access location 212. Also for example, the source quality 234 can be a number, a size, a luminance output, or a combination thereof for a peripheral display device, such as a projector or a computer screen, available at the access location 212.

The display can show an inference set 236, an access history 238, an optimal access selection 240, or a combination thereof. The inference set 236 is a set of the access location 212 inferred or learned by the computing system 100. The inference set 236 can be one or more instances of the access location 212 identified by the computing system 100.

For example, the computing system 100 can identify the inference set 236 using advertisements or user reviews available on the Internet. Also for example, the computing system 100 can identify the inference set 236 when the user accesses or uses the access location 212. Details regarding the identification of the inference set 236 will be discussed below.

The access history 238 is a record of user's access or usage for one or more instance of the access location 212. The access history 238 can include a date, a time, surrounding or related information, duration, nature of the access, or a combination thereof for each of the user's access or usage for one or more instance of the access location 212. The access history 238 can be associated with the inference set 236 and detail each of the user's access or usage for one or more instance of the access location 212 in the inference set 236.

The optimal access selection 240 is an identification of the access location 212, a specific instance of the resource 202, or a combination thereof recommended by the computing system 100 to the user. The optimal access selection 240 can be the access location 212 determined as most beneficial, required or necessary, or a combination thereof by the computing system 100. The optimal access selection 240 can further include different method or means for achieving a common goal, such as having a different time or a sequence for accessing a resource, a different medium, such as network bandwidth instead of cellular bandwidth, or a combination thereof. The optimal access selection 240 can be determined based on an activity 242, a context 244 or scheduling associated therewith, other usage or cost related information, or a combination thereof.

The activity 242 is an action or a movement related to the user. The activity 242 can be represented using an identification, a categorical value, or a combination thereof. The activity 242 can include occurrence of an event, such as a conference or a meeting, related to the user or scheduled for attendance by the user. The activity 242 can include one or more actions for performance by the user. The activity 242 can be the action performed, being performed, or to be performed by the user. The activity 242 can be associated with a usage of the first device 102, the second device 106, or a combination thereof by the user.

The context 244 is a representation of a situation, an environment, a purpose, a significance, or a combination thereof regarding the activity 242. The context 244 can be represented using an identification, a categorical value, a set of parameters, a machine-learning cluster or model, or a combination thereof for representing the situation, the environment, the purpose, the significance, or a combination thereof. The context 244 can be an abstraction of a value or a reason for the user regarding the activity 242.

The computing system 100 can determine the context 244 based on a contextual parameter 246. The contextual parameter 246 is situational or environmental information for the context 244 regarding the activity 242. The contextual parameter 246 can include an activity location or a current location 248, such as for the user or a user's device at the current time 206, purpose or goal related information as determined by the user or the computing system 100, participant identification information, an activity importance 250 for representing the significance as designated by the user or the computing system 100, or a combination thereof.

The contextual parameter 246 can further include a communication data 252, a behavioral data 254, a calendar entry 256, or a combination thereof. The communication data 252 is information sent from or received by the user. The communication data 252 can include information communicated with the first device 102, the second device 106, or a combination thereof. The communication data 252 can include email, other text-based message, data sent to or received from websites, posted or downloaded information, call history or content, or a combination thereof.

The behavioral data 254 is navigation information for movement or location of the user. The behavioral data 254 can include one or more locations or a sequence of locations for the first device 102, the second device 106, or a combination thereof. The behavioral data 254 can include a speed or a vector, a direction, a frequency, a pattern, or a combination thereof for the first device 102, the second device 106, or a combination thereof.

The calendar entry 256 is information included in a scheduling application used by the user. The calendar entry 256 can include scheduling information, a title, a participant, a note, other detail information, or a combination thereof for the activity 242. The computing system 100 can determine the activity 242, the context 244, or a combination thereof using or without using the calendar entry 256.

For example, the computing system 100 can identify a future activity estimation 258, a future context 260 associated therewith, or a combination thereof using the calendar entry 256, the communication data 252, the behavioral data 254, or a combination thereof. Also for example, the computing system 100 can identify the future activity estimation 258, the future context 260, or a combination thereof using the communication data 252, the behavioral data 254, or a combination thereof without the calendar entry 256.

The future activity estimation 258 is a predicted instance of the activity 242 occurring at the future time 210 after the current time 206. The future context 260 is the context 244 associated with the future activity estimation 258. Details regarding the identification of the future activity estimation 258 and the future context 260, along with determination of the optimal access selection 240 and other usage or cost related information will be described below.

The display can further show a resource planning content 262, a configuration-adjustment profile 264, or a combination thereof. The resource planning content 262 is information communicated to the user regarding accessing the resource 202 for the activity 242 at the future time 210. The resource planning content 262 can be a message generated by the first device 102, the second device 106, or a combination thereof and communicated, such as by displaying or recreating a sounds, to the user.

The resource planning content 262 can include the optimal access selection 240. The resource planning content 262 can further include additional information for accessing the resource 202 at the optimal access selection 240. For example, the resource planning content 262 can include an access-route 266, a schedule adjustment 268, or a combination thereof.

The access-route 266 is a course or a set of directions for the user to travel to access the resource 202 at the optimal access selection 240. The access-route 266 can be from a current location of the first device 102, a projected location of the user, a location of the activity 242, or a combination thereof to the optimal access selection 240.

The schedule adjustment 268 is a change in the activity 242 or the user's schedule to accommodate accessing the resource 202 at the optimal access selection 240. The schedule adjustment 268 can be a rearrangement or a change in one or more instances of the calendar entry 256 of FIG. 2. The schedule adjustment 268 can be based on the future activity estimation 258.

The configuration-adjustment profile 264 is a change in a setting value of the first device 102, the second device 106, or a combination thereof. For example, the configuration-adjustment profile 264 can include a change or an adjustment for a time-out duration, such as for turning off displays or for shorter or quieter audible output, display output or brightness, suspension of a function or a process, or a combination thereof. The configuration-adjustment profile 264 can be based on a user's response to the resource planning content 262.

The configuration-adjustment profile 264 can be based on an application priority 270. The application priority 270 is a description of importance for a function, a process, or a combination thereof. The application priority 270 can be based on the context 244, the activity 242, the access location 212, or a combination thereof.

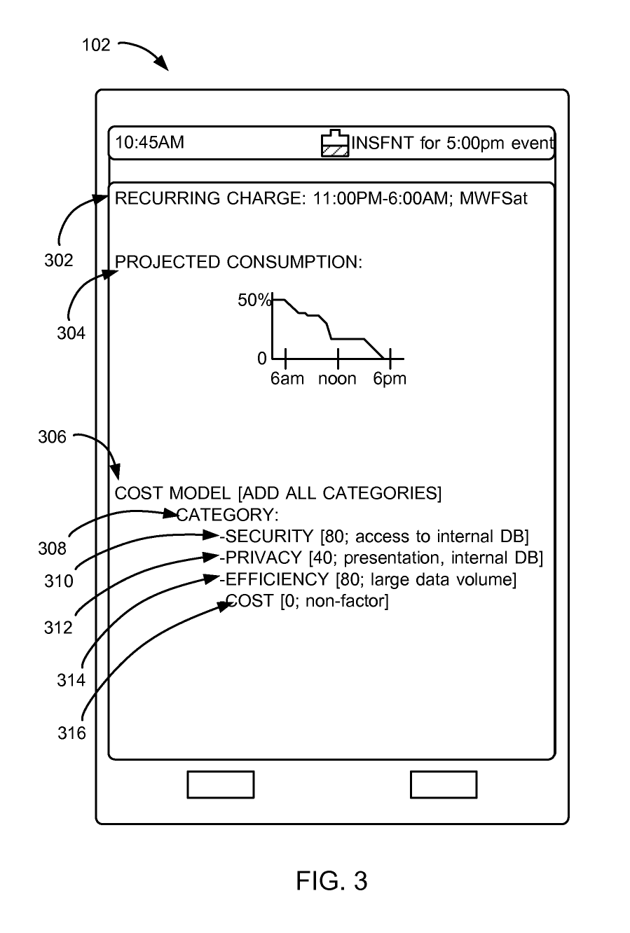

Referring now to FIG. 3, therein is shown a further example display of the first device 102. The display can show an access model 302, a consumption model 304, and a cost model 306.

The access model 302 is a description regarding user's access of the resource 202 of FIG. 2. The access model 302 can include a frequency, a pattern, or a combination thereof. The access model 302 can include a time, a date, a location, an instance of the context 244 of FIG. 2, a minimum or an average amount of the resource 202, or a combination thereof associated with the user's access of the resource 202.

For example, the access model 302 can include a determination that the user accesses display screens for performing certain tasks or for certain instances of the context 244. Also for example, the access model 302 can include a pattern that the user charges the first device 102 of FIG. 1 each night, when the available power goes below a certain level, before an instance of the activity 242 of FIG. 2 or the context 244, or a combination thereof. For further example, the access model 302 can include a user's preference for certain types of access to the network 104 of FIG. 1 based on various parameters, such as the contextual parameter 246 of FIG. 2 or the source attribute 216 of FIG. 2.

The consumption model 304 is a description of usage or consumption for the resource 202. The consumption model 304 can be predicted or estimated by the computing system 100 of FIG. 1.

For example, the consumption model 304 can describe a likely amount of power or electricity used by the first device 102, the second device 106 of FIG. 1, or a combination thereof or remaining in the device throughout different times of a day, a week, or a combination thereof. Also for example, the consumption model 304 can describe the amount of bandwidth likely necessary for using the first device 102, the second device 106, or a combination thereof for the future activity estimation 258 of FIG. 2, the future context 260 of FIG. 2, or a combination thereof.

For further example, the consumption model 304 can describe a detailed history of various device usages over time, pattern thereof, or a combination thereof. The consumption model 304 can describe the detailed history or pattern for bandwidth or power consumption per hour, per day. The consumption model 304 can describe locations, times, durations, or a combination thereof corresponding to each usage. The consumption model 304 including the data usage can be applicable for the user having a limitation on the data usage. The computing system 100 can notify the user when the user approaches the limitation, suggest an alternate method or means for the data usage, or a combination thereof.

The consumption model 304 can be based on the activity 242, the context 244, the access history 238 of FIG. 2, the inference set 236 of FIG. 2, the future context 260, the contextual parameter 246, projected or known instances of the source attribute 216, or a combination thereof. For example, the consumption model 304 can be based on the activity 242 or the future activity estimation 258, the current location 248 of FIG. 2, the location of the activity 242, the activity importance 250 of FIG. 2, or a combination thereof, the source quality 234 of FIG. 2, the security rating 224 of FIG. 2, or a combination thereof.

The cost model 306 is a mechanism for evaluating a cost for accessing the resource 202. The cost model 306 can include a method, an equation, or a combination thereof for measuring and evaluating time, money, effort, or a combination thereof required to access the resource 202. The cost model 306 can be used to compare the source attribute 216 for multiple instances of the access location 212.

The cost model 306 can further account for importance of various factors, such as by adjusting a weighting parameter or selecting a specific equation, based on the activity 242, the context 244, the contextual parameter 246, the user's preference, the source attribute 216, or a combination thereof.

The cost model 306 can include a cost-category 308. The cost-category 308 is a classification of an area or an aspect considered for evaluating the cost. The cost model 306 can be similar to the source attribute 216. For example, the cost-category 308 can include a security factor 310, a privacy factor 312, an efficiency factor 314, a cost factor 316, or a combination thereof.

The security factor 310 is a classification for considering the safety associated with the access location 212. The security factor 310 can be for evaluating the security rating 224. The privacy factor 312 is a classification for considering the exclusivity allowed or facilitated at the access location 212. The privacy factor 312 can be for evaluating the privacy rating 228.

The efficiency factor 314 is a classification for considering a performance regarding access to the resource 202 at the access location 212. The efficiency factor can be for evaluating the communication mode 230, the communication rate 232, the source quality 234, or a combination thereof.

The cost factor 316 is a classification for considering the expense to the user required to access the resource 202 at the access location 212. The cost factor 316 can be used to evaluate time, money, effort, usage of data or other resource, or a combination thereof for the user, as represented by the access cost 226. Details regarding the cost model 306 will be discussed below.

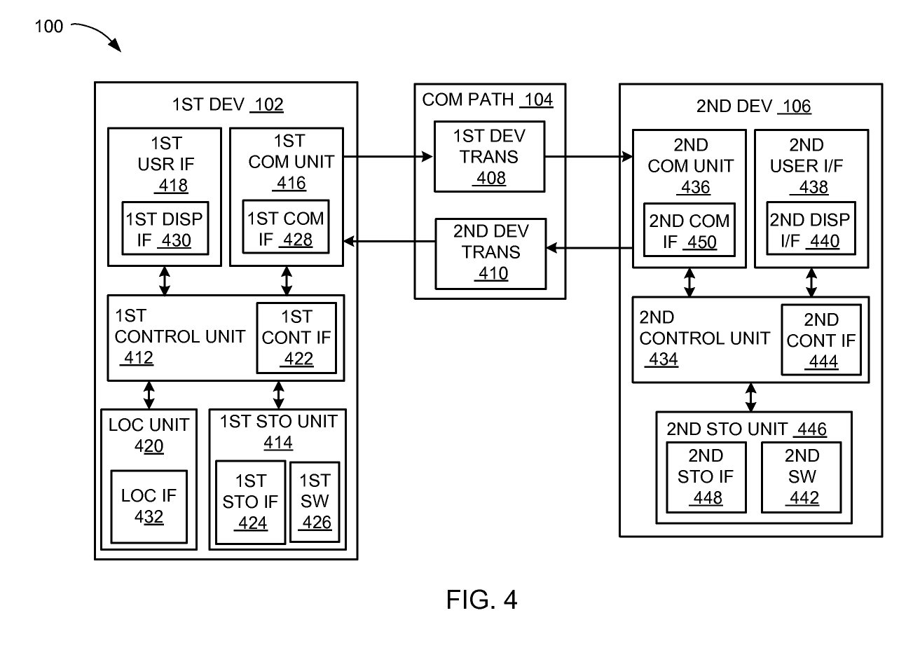

Referring now to FIG. 4, therein is shown an exemplary block diagram of the computing system 100. The computing system 100 can include the first device 102, the communication path 104, and the second device 106. The first device 102 can send information in a first device transmission 408 over the communication path 104 to the second device 106. The second device 106 can send information in a second device transmission 410 over the communication path 104 to the first device 102.

For illustrative purposes, the computing system 100 is shown with the first device 102 as a client device, although it is understood that the computing system 100 can have the first device 102 as a different type of device. For example, the first device 102 can be a server having a display interface.

Also for illustrative purposes, the computing system 100 is shown with the second device 106 as a server, although it is understood that the computing system 100 can have the second device 106 as a different type of device. For example, the second device 106 can be a client device.

For brevity of description in this embodiment of the present invention, the first device 102 will be described as a client device and the second device 106 will be described as a server device. The embodiment of the present invention is not limited to this selection for the type of devices. The selection is an example of an embodiment of the present invention.

The first device 102 can include a first control unit 412, a first storage unit 414, a first communication unit 416, and a first user interface 418, and a location unit 420. The first control unit 412 can include a first control interface 422. The first control unit 412 can execute a first software 426 to provide the intelligence of the computing system 100.

The first control unit 412 can be implemented in a number of different manners. For example, the first control unit 412 can be a processor, an application specific integrated circuit (ASIC) an embedded processor, a microprocessor, a hardware control logic, a hardware finite state machine (FSM), a digital signal processor (DSP), or a combination thereof. The first control interface 422 can be used for communication between the first control unit 412 and other functional units in the first device 102. The first control interface 422 can also be used for communication that is external to the first device 102.

The first control interface 422 can receive information from the other functional units or from external sources, or can transmit information to the other functional units or to external destinations. The external sources and the external destinations refer to sources and destinations external to the first device 102.

The first control interface 422 can be implemented in different ways and can include different implementations depending on which functional units or external units are being interfaced with the first control interface 422. For example, the first control interface 422 can be implemented with a pressure sensor, an inertial sensor, a microelectromechanical system (MEMS), optical circuitry, waveguides, wireless circuitry, wireline circuitry, or a combination thereof.

The first storage unit 414 can store the first software 426. The first storage unit 414 can also store the relevant information, such as data representing incoming images, data representing previously presented image, sound files, or a combination thereof.

The first storage unit 414 can be a volatile memory, a nonvolatile memory, an internal memory, an external memory, or a combination thereof. For example, the first storage unit 414 can be a nonvolatile storage such as non-volatile random access memory (NVRAM), Flash memory, disk storage, or a volatile storage such as static random access memory (SRAM).

The first storage unit 414 can include a first storage interface 424. The first storage interface 424 can be used for communication between the first storage unit 414 and other functional units in the first device 102. The first storage interface 424 can also be used for communication that is external to the first device 102.

The first storage interface 424 can receive information from the other functional units or from external sources, or can transmit information to the other functional units or to external destinations. The external sources and the external destinations refer to sources and destinations external to the first device 102.

The first storage interface 424 can include different implementations depending on which functional units or external units are being interfaced with the first storage unit 414. The first storage interface 424 can be implemented with technologies and techniques similar to the implementation of the first control interface 422.

The first communication unit 416 can enable external communication to and from the first device 102. For example, the first communication unit 416 can permit the first device 102 to communicate with the second device 106 of FIG. 1, an attachment, such as a peripheral device or a desktop computer, and the communication path 104.

The first communication unit 416 can also function as a communication hub allowing the first device 102 to function as part of the communication path 104 and not limited to be an end point or terminal unit to the communication path 104. The first communication unit 416 can include active and passive components, such as microelectronics or an antenna, for interaction with the communication path 104.

The first communication unit 416 can include a first communication interface 428. The first communication interface 428 can be used for communication between the first communication unit 416 and other functional units in the first device 102. The first communication interface 428 can receive information from the other functional units or can transmit information to the other functional units.

The first communication interface 428 can include different implementations depending on which functional units are being interfaced with the first communication unit 416. The first communication interface 428 can be implemented with technologies and techniques similar to the implementation of the first control interface 422.

The first user interface 418 allows a user (not shown) to interface and interact with the first device 102. The first user interface 418 can include an input device and an output device. Examples of the input device of the first user interface 418 can include a keypad, a touchpad, soft-keys, a keyboard, a microphone, an infrared sensor for receiving remote signals, or any combination thereof to provide data and communication inputs.

The first user interface 418 can include a first display interface 430. The first display interface 430 can include an output device, such as the display interface 202 of FIG. 2. The first display interface 430 can include a display, a projector, a video screen, a speaker, or any combination thereof.

The first control unit 412 can operate the first user interface 418 to display information generated by the computing system 100. The first control unit 412 can also execute the first software 426 for the other functions of the computing system 100, including receiving location information from the location unit 420. The first control unit 412 can further execute the first software 426 for interaction with the communication path 104 via the first communication unit 416.

The location unit 420 can generate location information, current heading, current acceleration, and current speed of the first device 102, as examples. The location unit 420 can be implemented in many ways. For example, the location unit 420 can function as at least a part of the global positioning system, an inertial computing system, a cellular-tower location system, a pressure location system, or any combination thereof. Also, for example, the location unit 620 can utilize components such as an accelerometer or GPS receiver.

The location unit 420 can include a location interface 432. The location interface 432 can be used for communication between the location unit 420 and other functional units in the first device 102. The location interface 632 can also be used for communication external to the first device 102.

The location interface 432 can receive information from the other functional units or from external sources, or can transmit information to the other functional units or to external destinations. The external sources and the external destinations refer to sources and destinations external to the first device 102.

The location interface 432 can include different implementations depending on which functional units or external units are being interfaced with the location unit 420. The location interface 432 can be implemented with technologies and techniques similar to the implementation of the first control unit 412.

The second device 106 can be optimized for implementing an embodiment of the present invention in a multiple device embodiment with the first device 102. The second device 106 can provide the additional or higher performance processing power compared to the first device 102. The second device 106 can include a second control unit 434, a second communication unit 436, a second user interface 438, and a second storage unit 446.

The second user interface 438 allows a user (not shown) to interface and interact with the second device 106. The second user interface 438 can include an input device and an output device. Examples of the input device of the second user interface 438 can include a keypad, a touchpad, soft-keys, a keyboard, a microphone, or any combination thereof to provide data and communication inputs. Examples of the output device of the second user interface 438 can include a second display interface 440. The second display interface 440 can include a display, a projector, a video screen, a speaker, or any combination thereof.

The second control unit 434 can execute a second software 442 to provide the intelligence of the second device 106 of the computing system 100. The second software 442 can operate in conjunction with the first software 426. The second control unit 434 can provide additional performance compared to the first control unit 412.

The second control unit 434 can operate the second user interface 438 to display information. The second control unit 434 can also execute the second software 442 for the other functions of the computing system 100, including operating the second communication unit 436 to communicate with the first device 102 over the communication path 104.

The second control unit 434 can be implemented in a number of different manners. For example, the second control unit 434 can be a processor, an embedded processor, a microprocessor, hardware control logic, a hardware finite state machine (FSM), a digital signal processor (DSP), or a combination thereof.

The second control unit 434 can include a second control interface 444. The second control interface 444 can be used for communication between the second control unit 434 and other functional units in the second device 106. The second control interface 444 can also be used for communication that is external to the second device 106.

The second control interface 444 can receive information from the other functional units or from external sources, or can transmit information to the other functional units or to external destinations. The external sources and the external destinations refer to sources and destinations external to the second device 106.

The second control interface 444 can be implemented in different ways and can include different implementations depending on which functional units or external units are being interfaced with the second control interface 444. For example, the second control interface 444 can be implemented with a pressure sensor, an inertial sensor, a microelectromechanical system (MEMS), optical circuitry, waveguides, wireless circuitry, wireline circuitry, or a combination thereof.

A second storage unit 446 can store the second software 442. The second storage unit 446 can also store the information such as data representing incoming images, data representing previously presented image, sound files, or a combination thereof. The second storage unit 446 can be sized to provide the additional storage capacity to supplement the first storage unit 414.

For illustrative purposes, the second storage unit 446 is shown as a single element, although it is understood that the second storage unit 446 can be a distribution of storage elements. Also for illustrative purposes, the computing system 100 is shown with the second storage unit 446 as a single hierarchy storage system, although it is understood that the computing system 100 can have the second storage unit 446 in a different configuration. For example, the second storage unit 446 can be formed with different storage technologies forming a memory hierarchal system including different levels of caching, main memory, rotating media, or off-line storage.

The second storage unit 446 can be a volatile memory, a nonvolatile memory, an internal memory, an external memory, or a combination thereof. For example, the second storage unit 446 can be a nonvolatile storage such as non-volatile random access memory (NVRAM), Flash memory, disk storage, or a volatile storage such as static random access memory (SRAM).

The second storage unit 446 can include a second storage interface 448. The second storage interface 448 can be used for communication between the second storage unit 446 and other functional units in the second device 106. The second storage interface 448 can also be used for communication that is external to the second device 106.

The second storage interface 448 can receive information from the other functional units or from external sources, or can transmit information to the other functional units or to external destinations. The external sources and the external destinations refer to sources and destinations external to the second device 106.

The second storage interface 448 can include different implementations depending on which functional units or external units are being interfaced with the second storage unit 446. The second storage interface 448 can be implemented with technologies and techniques similar to the implementation of the second control interface 444.

The second communication unit 436 can enable external communication to and from the second device 106. For example, the second communication unit 436 can permit the second device 106 to communicate with the first device 102 over the communication path 104.

The second communication unit 436 can also function as a communication hub allowing the second device 106 to function as part of the communication path 104 and not limited to be an end point or terminal unit to the communication path 104. The second communication unit 436 can include active and passive components, such as microelectronics or an antenna, for interaction with the communication path 104.

The second communication unit 436 can include a second communication interface 450. The second communication interface 450 can be used for communication between the second communication unit 436 and other functional units in the second device 106. The second communication interface 450 can receive information from the other functional units or can transmit information to the other functional units.

The second communication interface 450 can include different implementations depending on which functional units are being interfaced with the second communication unit 436. The second communication interface 450 can be implemented with technologies and techniques similar to the implementation of the second control interface 444.

The first communication unit 416 can couple with the communication path 104 to send information to the second device 106 in the first device transmission 408. The second device 106 can receive information in the second communication unit 436 from the first device transmission 408 of the communication path 104.

The second communication unit 436 can couple with the communication path 104 to send information to the first device 102 in the second device transmission 410. The first device 102 can receive information in the first communication unit 416 from the second device transmission 410 of the communication path 104. The computing system 100 can be executed by the first control unit 412, the second control unit 434, or a combination thereof. For illustrative purposes, the second device 106 is shown with the partition having the second user interface 438, the second storage unit 446, the second control unit 434, and the second communication unit 436, although it is understood that the second device 106 can have a different partition. For example, the second software 442 can be partitioned differently such that some or all of its function can be in the second control unit 434 and the second communication unit 436. Also, the second device 106 can include other functional units not shown in FIG. 4 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the computing system 100 is described by operation of the first device 102 and the second device 106. It is understood that the first device 102 and the second device 106 can operate any of the modules and functions of the computing system 100.

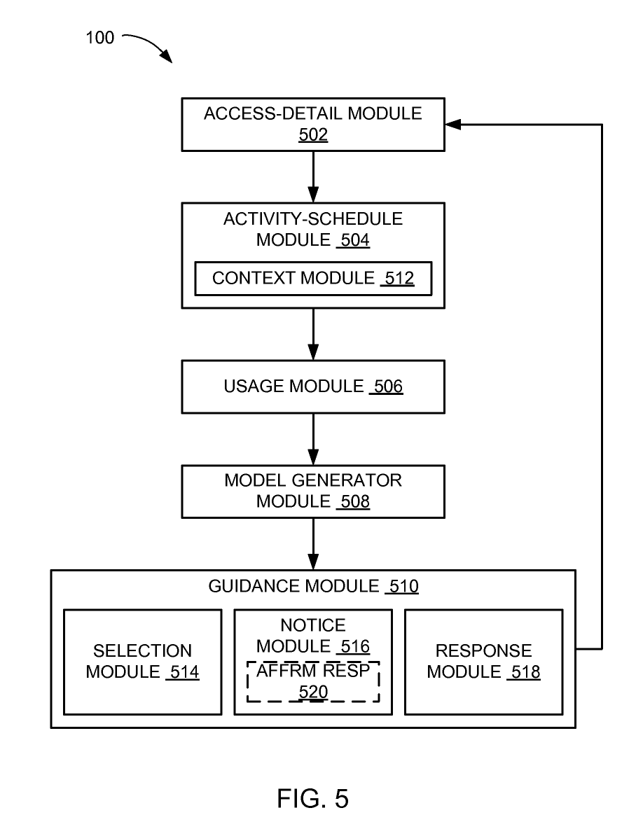

Referring now to FIG. 5, therein is shown a control flow of the computing system 100. The computing system 100 can include an access-detail module 502, an activity-schedule module 504, a usage module 506, a model generator module 508, and a guidance module 510.

The access-detail module 502 can be coupled to the activity-schedule module 504 using wired or wireless connections, by having an output of one module as an input of the other module, by having operations of one module influence operation of the other module, or a combination thereof. Similarly, the activity-schedule module 504 can be coupled to the usage module 506. Moreover, the usage module 506 can be similarly coupled to the model generator module 508, and the model generator module 508 can be coupled to the guidance module 510, which can be further coupled to the access-detail module 502.

The access-detail module 502 is configured to detail the user's access or usage of the resource 202. The access-detail module 502 can determine the access history 238 of FIG. 2.

The access-detail module 502 can use the first user interface 418 of FIG. 4, the second user interface 438 of FIG. 4, the first communication unit 416 of FIG. 4, the second communication unit 436 of FIG. 4, or a combination thereof to detect and identify connection to the resource 202 external to the first device 102 of FIG. 1, the second device 106 of FIG. 1, or a combination thereof. For example, the access-detail module 502 can identify and detect exchange of data, increase in power level or connection to a charging port, identification information of a peripheral device or access to a function requiring the peripheral device, or a combination thereof using one or more of the units in the first device 102, the second device 106, or a combination thereof.

The access-detail module 502 can record various details regarding the access to determine the access history 238. The access-detail module 502 can identify the current time 206 of FIG. 2 at the time of the access and record the value into the access history 238. The access-detail module 502 can further identify the current location 248 of FIG. 2 at the time of detection and identification of connection to the resource 202 as the access location 212 of FIG. 2. The access-detail module 502 can record the access location 212 in association with the current time 206 into the access history 238.

The access-detail module 502 can further identify and record the access type 214 of FIG. 2, the source attribute 216 of FIG. 2, or a combination thereof for the access location 212. The access-detail module 502 can identify the access type 214 based on exchanged identification data for accessing the resource 202, the identity of the function or feature executed through accessing the resource 202, the port being accessed for the resource 202, change in configuration or data state of the device, or a combination thereof.

The access-detail module 502 can identify the source attribute 216 in a variety of ways. For example, the access-detail module 502 can identify and record the source attribute 216 from information received regarding the resource 202, such as the communication mode 230 of FIG. 2, the security rating 224 of FIG. 2, the access cost 226 of FIG. 2, or a combination thereof. As a more specific example, the access-detail module 502 can receive monetary cost related information from the provider of the resource 202, configuration related information regarding the communication mode 230 or encryption methods, or a combination thereof.

Also for example, the access-detail module 502 can identify and record the source attribute 216 using various databases or websites. The access-detail module 502 can receive identification information of the provider of the resource 202, such as a device identification or a provider name. The access-detail module 502 can search the Internet or various databases based on the identification information. As a more specific example, the access-detail module 502 can determine and record the access cost 226 or the security rating 224 from the provider's website, the privacy rating 228 of FIG. 2 or the source quality 234 of FIG. 2 from a rating website, a database, or a social media website, or a combination thereof.

As a further example, the access-detail module 502 can identify the source attribute 216 by measuring and recording various factors. As a more specific example, the access-detail module 502 can determine an amount of time, change in stored energy, a charging rate, or a combination thereof for the energy stored in the first device 102, the second device 104, or a combination thereof. The access-detail module 502 can store the information as the source quality 234, the access cost 226, or a combination thereof.

The access-detail module 502 can further record other information associated with the access in the access history 238. For example, the access-detail module 502 can record the context 244 of FIG. 2, the contextual parameter 246 of FIG. 2, the calendar entry 256 of FIG. 2, the activity 242 of FIG. 2, or a combination thereof associated with the access for the resource 202 at the access location 212 in the access history 238. Details for determining the other associated information will be described below.

The access-detail module 502 can determine an initial grouping of the access location 212 available to the user or further processing. The access-detail module 502 can determine the inference set 236 of FIG. 2. The access-detail module 502 can determine the inference set 236 from the access history 238 for accessing the resource 202. The access-detail module 502 can determine the inference set 236 as the instances of the access location 212 in the access history 238 meeting one or more requirement.

For example, the inference set 236 can include all instances of the access location 212 directly used or accessed by the user, the first device 102, the second device 106, or a combination thereof in the access history 238. Also for example, the inference set 236 can include instances of the access location 212 in the access history 238 selected based on the access type 214, the source attribute 216, geographic distance between the access location 212 and the current location 248, or a combination thereof.

The access-detail module 502 can further describe behavior or patterns involving the resource 202. The access-detail module 502 can generate the access model 302 of FIG. 3. The access-detail module 502 can generate the access model 302 for representing access or usage of the resource 202 for using the device, such as charging pattern or usage pattern over time, the context 244, the activity 242, or a combination thereof.

The access-detail module 502 can generate the access model 302 can generate the access model 302 by determining a pattern based on time, location, the context 244, or a combination thereof associated with usage or access of the access location 212 in the access history 238. For example, the access-detail module 502 can use a process, a mechanism, a method, an equation, a threshold, or a combination thereof predetermined for determining the pattern of access for the resource 202. Also for example, the access-detail module 502 can use a machine-learning mechanism to determine a cluster, a model, or a combination thereof as the pattern of access for the resource 202.

The access-detail module 502 can prioritize or sort the instances of the access location 212 in the access history 238 or the inference set 236 by last-used date or time, frequency of use, similarities, user's preference, or a combination thereof. The access-detail module 502 can adjust the access history 238 or the inference set 236 by eliminating records of older or single use locations based on criteria, such as elapsed duration since last access or the context 244.

After processing the access location 212, the control flow can pass from access-detail module 502 to the activity-schedule module 504. The control flow can pass by having the access location 212, the inference set 236, the access history 238, the access model 302, or a combination thereof as an output from the access-detail module 502 to an input of the activity-schedule module 504, storing the access location 212, the inference set 236, the access history 238, the access model 302, or a combination thereof at a location known and accessible to the activity-schedule module 504, by notifying the activity-schedule module 504, such as by using a flag, an interrupt, a status signal, or a combination thereof, or a combination of processes thereof.

The activity-schedule module 504 is configured to process the user's ongoing or upcoming activities. The activity-schedule module 504 can determine the contextual parameter 246 and use the contextual parameter 246 to identify the activity 242, the context 244 associated therewith, or a combination thereof for the current time 206, the future time 210, or a combination thereof.

The activity-schedule module 504 can determine the contextual parameter 246 using various methods. For example, the activity-schedule module 504 can determine current location 248 using the location unit 420 of FIG. 4. Also for example, the activity-schedule module 504 can use the first user interface 418, the second user interface 438, the first communication unit 416, the second communication unit 436, the first control unit 412 of FIG. 4, the second control unit 434 of FIG. 4, the location unit 420, or a combination thereof to determine the behavioral data 254 of FIG. 2. As a further example, the activity-schedule module 504 can determine the communication data 252 using the first user interface 418, the second user interface 438, the first communication unit 416, the second communication unit 436, or a combination thereof.

The activity-schedule module 504 can identify the activity 242 based on the calendar entry 256, the contextual parameter 246, or a combination thereof. For example, the activity-schedule module 504 can determine the activity 242 as the event in the user's calendar scheduled at the current time 206, scheduled at a location matching the current location 248, or a combination thereof.

Also for example, the activity-schedule module 504 can determine the activity 242 without the calendar entry 256. The activity-schedule module 504 can determine the activity 242 based on the current location 248, the communication data 252, the behavioral data 254, or a combination thereof. The activity-schedule module 504 can identify a keyword, a specific behavior pattern, such as deviation from a planned route or a change in speed, or a combination thereof in the communication data 252, the behavioral data 254, or a combination thereof.

As a more specific example, “leaving now” or “I am here” sent or received over email or text message can signal a beginning or an end of the activity 242 associated with the current location 248. Also as a more specific example, unplanned deviation from the current route or a change in a pattern of user's behavior can signal a change in the activity 242 or the activity importance 250 of FIG. 2 and initiate a further processing of the behavioral data 254, the communication data 252, or a combination thereof for determining an updated instance of the activity 242.

The activity-schedule module 504 can estimate the activity 242 occurring at the future time 210 after the current time 206 by identifying the future activity estimation 258 of FIG. 2. The activity-schedule module 504 can identify the future activity estimation 258 based on the contextual parameter 246. For example, the activity-schedule module 504 can identify the future activity estimation 258 based on the communication data 252, the behavioral data 254, or a combination thereof.

As a more specific example, the activity-schedule module 504 can identify the future activity estimation 258 based on one or more keywords includes in the communication data 252, such as time, location, other contextual information, user's intent or participant's intent, or a combination thereof. Also as a more specific example, the activity-schedule module 504 can identify the future activity estimation 258 based on a cluster or a model for a pattern of behavior and a current instance of the activity 242.

The activity-schedule module 504 can include a context module 512. The context module 512 is configured to determine the context 244 associated with the activity 242. The context module 512 can determine the context 244 based on the contextual parameter 246. The context module 512 can determine the context 244 as a category, an identifier, or a combination thereof matching the contextual parameter 246.

The context module 512 can further determine a context-cluster, a context-model, or a combination thereof using the contextual parameter 246 for determining the context 244 associated with the activity 242. The context module 512 can further determine the context 244 using pattern analysis for the contextual parameter 246.

The context module 512 can determine the context 244 for the activity occurring at the current time 206 or estimated to occur at the future time. The context module 512 can determine the future context 260 of FIG. 2. For example, the context module 512 can determine the future context 260 using a keyword, a user's pattern, a cluster or a model, or a combination thereof as described above associated with the future time 210, the future activity estimation 258, or a combination thereof.

The context module 512 can determine the future context 260 with or without the use of the calendar entry 256. For example, the context module 512 can use keywords from the calendar entry 256, the communication data 252, or a combination thereof. Also for example, the context module 512 can use the communication data 252, the behavioral data 254, or a combination thereof, but without any information from the calendar entry 256.

After determining the activity 242 and the context 244, the control flow can pass from the activity-schedule module 504 to the usage module 506. The control flow can pass similarly as described above between the access-detail module 502 and the activity-schedule module 504.

The usage module 506 is configured to process usage information for the resource 202 over time. The usage module 506 can use the first control interface 422 of FIG. 4, the second control interface 444 of FIG. 4, or a combination thereof to determine the current resource-status 204 of FIG. 2. The usage module 506 can further use the first storage interface 424 of FIG. 4, the second storage interface 448 of FIG. 4, or a combination thereof to access usage information or previously recorded instances of the current resource-status 204 in the access history 238.

The usage module 506 can generate the consumption model 304 for estimating usage of the resource 202 after the current time 206. The usage module 506 can further generate the consumption model 304 for describing an availability or an amount of the resource 202 available for usage with the first device 102, the second device 106, or a combination thereof. The usage module 506 can generate the consumption model 304 based on previous usage, current usage, estimated future usage, or a combination thereof including the current resource-status 204, the access history 238, the future activity estimation 258, or a combination thereof.

For example, the usage module 506 can generate the consumption model 304 using an hourly model, an event based model, a daily or weekly model, or a combination thereof by sampling and recording the power level at regular times or intervals. As a more specific example, the consumption model 304 can determine the amount or accessibility of the resource 202 for the first device 102, the second device 106, or a combination thereof at a designated time for each hour or each day and building a history of those values and the differences between them. The usage module 506 can use the recorded values to predict the likely power drain based on time, the context 244, the activity 242 or a combination thereof.

Also as a more specific example, the usage module 506 can generate the consumption model 304 based on days of the week, such as Monday or Friday, based on a monthly model, such as for data cap usage, or a combination thereof. The monthly model can be adjustable to designate any day of the month as a starting point and a corresponding date in an adjacent month as an ending point.

As a further specific example, the usage module 506 can generate the consumption model 304 based on a season, such as summer or baseball season, an event or duration, such as a school year or a national conference, or a combination thereof. The usage module 506 can identify and use dates having significance, such as solstice, equinox, first day of school, season opening date, conference dates, or a combination thereof to generate the consumption model. The usage module 506 can further identify and use dates having reoccurring significance, such as birthdays, holidays, vacations, memorials, anniversaries, or a combination thereof.

The usage module 506 can generate the consumption model 304 based on the access history 238 acquired over time. The usage module 506 can generate the consumption model 304 using an equation, a usage model, a usage rate, a likelihood of usage of a function or a feature, or a combination thereof predetermined by the computing system 100. The usage module 506 can further generate the consumption model 304 based on a coverage area, a previous usage history, a pattern of usage, the future activity estimation 258, the future context 260, or a combination thereof.

The usage module 506 can generate the consumption model 304 further associated with the future activity estimation 258. The usage module 506 can generate the consumption model 304 for a time period up to, including, or after the future time 210 corresponding to the future activity estimation 258. The usage module 506 can use the consumption model 304 to estimate the future resource-status 208 of FIG. 2 for estimating an amount of resource 202 likely available at the future time 210 for the future activity estimation 258.

After processing the usage information for the resource 202, the control flow can pass from the usage module 506 to the model generator module 508. The control flow can pass similarly as described above between the access-detail module 502 and the activity-schedule module 504.

The model generator module 508 is configured to determine a mechanism for evaluating the access location 212 based on the context 244 and the activity 242. The model generator module 508 can determine the cost model 306 of FIG. 3 for evaluating the access location 212. The model generator module 508 can determine the cost model 306 using the first control unit 412, the second control unit 434, or a combination thereof to account for the value or the importance of different factors surrounding the context 244, the activity 242, or a combination thereof. The model generator module 508 can determine the cost model 306 for the activity 242 or the context 244 at the current time 206 or the future activity estimation 258 or the future context 260 at the future time 210.

The model generator module 508 can determine the cost model 306 including one or more instances of the cost-category 308 of FIG. 3. The model generator module 508 can determine the cost-category 308 as a factor having importance to the user regarding the activity 242 or the context 244. For example, the model generator module 508 can determine the cost-category 308 as the security factor 310 of FIG. 3, the privacy factor 312 of FIG. 3, the efficiency factor 314 of FIG. 3, the cost factor 316 of FIG. 3, or a combination thereof.

The model generator module 508 can determine the cost model 306 by assigning a value to the cost-category 308, combining more than one instance of the cost-category 308, or a combination thereof. The model generator module 508 can assign the value to the cost-category 308 based on the context 244, the contextual parameter 246, the activity 242, the future activity estimation 258, the future context 260, the access history 238, the consumption model 304, or a combination thereof.

The model generator module 508 can assign the value, combine multiple instances of the cost-category 308 in various ways. For example, the model generator module 508 can include an equation, a database, a method or process, or a combination thereof for determining a value for one or more cost-category 308 predetermined by the computer system 100. Also for example, the model generator module 508 can include a baseline equation or a method for combining multiple instances of the cost-category 308 according to the context 244.

As a more specific example, the model generator module 508 can include an initial value for the cost-category 308, with all instances of the cost-category 308 added together. The model generator module 508 can determine the cost model 306 by adjust the initial value for one or more instances of the cost-category 308 according to the context 244 or the contextual parameter 246, such as by increasing the value when an instance of the cost-category 308 is predetermined by the computing system 100 or the user as being more important than others and decreasing the value when the cost-category 308 is determined to be less important.

Also as a more specific example, the model generator module 508 can include multiple scenarios describing specific values for the context 244, the contextual parameter 246, or a combination thereof, associated with values for the cost-category 308. The model generator module 508 can evaluate the cost-category 308 by assigning the values corresponding to the scenario matching the determined instance of the context 244, the contextual parameter 246, or a combination thereof.

As a further specific example, the model generator module 508 can similarly include multiple different equations or methods for combining the contextual parameter 246, each having different mathematical operations using different instances of the cost-category 308. The model generator module 508 can select the equation or the method for combining the categories to determine the cost model 306 based on matching the context 244, the contextual parameter 246, or a combination thereof.

It has been discovered that the cost model 306 having the cost-category 308 for evaluating the security factor 310, the privacy factor 312, the efficiency factor 314, the cost factor 316, or a combination thereof provides a method of evaluating abstract factors having importance to the user. The cost-category 308 can quantize the abstract factors the user would consider based on the context 244. The quantized values can be further processed to determine the access location 212 most appropriate for the user given the activity 242 and the context 244 surrounding the user at the current time 206 and at the future time 210.

It has also been discovered that the cost model 306 based on the activity 242, the context 244, the consumption model 304, or a combination thereof provides contextually relevant evaluation for the access location 212. The cost model 306 based on the activity 242, the context 244, the consumption model 304, or a combination thereof can account for the information current and relevant to the user and use such information in evaluating and selecting the access location 212.

After determining the cost model 306, the control flow can pass from the model generator module 508 to the guidance module 510. The control flow can pass similarly as described above between the access-detail module 502 and the activity-schedule module 504.

The guidance module 510 is configured to inform the user of the current resource-status 204, the future resource-status 208, or a combination thereof. The guidance module 510 can be further configured to inform the user and facilitate the user in implementing possible actions associated with the current resource-status 204, the future resource-status 208, or a combination thereof. The guidance module 510 can use the first user interface 418, the second user interface 438, the first control unit 412, the second control unit 434, or a combination thereof to inform or facilitate the user.

The guidance module 510 can identify an update condition. The guidance module 510 can identify the update condition based on the current resource-status 204, the future resource-status 208, or a combination thereof being insufficient for performing the activity 242, the future estimated activity 242, or a combination thereof.

The guidance module 510 can use the current resource-status 204 as a starting point. The guidance module 510 can process the consumption model 304 to determine the future resource-status 208. The guidance module 510 can identify the update condition when the future resource-status 208 is insufficient to facilitate the future activity estimation 258. The guidance module 510 can also identify the update condition when the current resource-status 204 is insufficient to facilitate the activity 242 occurring at the current time 206 or the future activity estimation 258.

For example, the guidance module 510 can identify the update condition when the power level in the first device 102, the second device 106, or a combination thereof is insufficient to perform the functions necessary or likely necessary for the activity 242, the future activity estimation 258, an instance of the activity 242 before or after a specific instance of the activity, or a combination thereof. Also for example, the guidance module 510 can identify the update condition when the user's bandwidth usage or amount of stored data is above a threshold and a projected additional usage or storage is above a different threshold.

As a further example, the guidance module 510 can identify the update condition when the context 244 or the contextual parameter 246 at the current time 206 indicates a deviation from the access model 302, exceeding an allowable window, or a combination thereof. Also as a further example, the guidance module 510 can identify the update condition based on a requirement for the resource 202 for the activity 242 or the future activity estimation 258, such as requiring an access to a printer before a meeting or a projector during the meeting.

The guidance module 510 can initiate appropriate processes, including selecting the access location 212, notifying or facilitating the user regarding accessing the resource 202, determine the user's response, or a combination thereof based on identifying the update condition. The guidance module 510 can include a selection module 514, a notice module 516, a response module 518, or a combination thereof for the appropriate processes.

The selection module 514 is configured to determine the optimal access selection 240 for accessing the resource 202. The selection module 514 can determine the optimal access selection 240 based on the access location 212, the inference set 236, the cost model 306, the consumption model 304, the context 244, the activity 242, the future context 260, the future activity estimation 258, or a combination thereof.

For example, the selection module 514 can determine the optimal access selection 240 only from the inference set 236 representing user-trusted or user-experienced sources. Also for example, the selection module 514 can determine the optimal access selection 240 as the access location 212 accessible to the user, such as within a threshold distance from the current location 248 or having a specific value for the access type 214, given the consumption model 304 and a specific value of the access type 214 as required by the context 244, the activity 242, the current resource-status 204, the future resource-status 208, or a combination thereof.

It has been discovered that optimal access selection 240 from the inference set 236 provides reliable and trustworthy instance of the access location 212. The inference set 236 can reflect the user's preferences and trustworthiness based on ongoing updates thereto based on the user's own behaviors, patterns, or choices. Selecting from the inference set 236 can thusly insure that the optimal access selection 240 is a suitable instance of the access location 212, which is likely to be reliable and trustworthy.

As a further example, the selection module 514 can determine the optimal access selection 240 based on comparing the access type 214, the source attribute 216, or a combination thereof as listed above to the cost model 306 as listed above, the context 244, the activity 242, the future context 260, the future activity estimation 258, or a combination thereof. As a more specific example, the selection module 514 can evaluate instances of the access location 212, such as by performing a calculation or by sorting based on requirements, using the access type 214, the source attribute 216, the cost model 306, or a combination thereof.

Continuing with the example, the selection module 514 can determine the optimal access selection 240 as the access location 212 having the requirements described by the cost model 306 included in the access type 214, the source attribute 216, or a combination thereof. The selection module 514 can further determine the optimal access selection 240 as the access location 212 having the highest or the lowest score from the evaluation and comparison using the access type 214, the source attribute 216, or a combination thereof in light of the cost model 306.

It has been discovered that the optimal access selection 240 based on the cost model 306, including a correspondence between the source attribute 216, the access type 214, or a combination thereof and the cost-category 308, provides an accurate assessment for comparing instances of the access location 212 according to the context 244, the activity 242, or a combination thereof. The cost model 306 can be used to identify the importance of various factors given a set of circumstances. The source attribute 216, the access type 214, or a combination thereof for instances of the access location 212 can be compared and evaluated using the cost model 306. The optimal access selection 240 resulting therefrom can thus represent a contextually-relevant selection given the user's circumstances.

Also as a further example, the selection module 514 can determine the optimal access selection 240 based on similarity to previous situation. The selection module 514 can use the cost model 306 for assessing similarity between a current instance of the activity 242, the future activity estimation 258, the context 244, the future context 260, or a combination thereof to previous instances thereof in the access history 238. The selection module 514 can determine the optimal access selection 240 as the access location 212 previously used under the closest set of circumstances, most frequently accessed under similar circumstances, or a combination thereof.

The notice module 516 is configured to generate the resource planning content 262 for informing the user of the circumstances involving the resource 202. The notice module 516 can generate the resource planning content 262 using the first user interface 418, the second user interface 438, the first control unit 412, the second control unit 434, or a combination thereof. The notice module 516 can further generate the resource planning content 262 by communicating content information, such as by displaying or recreating a sequence of sounds, to the user, receiving inputs or making determinations regarding the user, or a combination thereof.

The notice module 516 can generate the resource planning content 262 including the optimal access selection 240 or information associated therewith. The notice module 516 can generate the resource planning content 262 by notifying the user of the circumstances regarding the resource 202, such as having insufficient power or requiring a printer, informing the user of the access location 212 suitable to the user with the optimal access selection 240 based on various factors associated with the user, such as the context 244, the future context 260, the schedule of the user, the future activity estimation 258, the access type 214, the source attribute 216, the access history 238, the activity 242, the consumption model 304, the cost model 306, the access model 302, or a combination thereof as described above.

The notice module 516 can generate the resource planning content 262 for managing the resource 202. The notice module 516 can inform the user regarding the resource 202, inform the user of the optimal access selection 240, facilitate access to the resource 202 at the access location 212, or a combination thereof through the resource planning content 262. For example, the notice module 516 can generate the resource planning content 262 including the access-route 266 of FIG. 2, the schedule adjustment 268 of FIG. 2, or a combination thereof based on the future activity estimation 258.

The notice module 516 can generate the access-route 266 by calculating a sequence of road segments, intersections, corresponding maneuvers and directions, corresponding guidance instructions, or a combination thereof for traversing between the current location 248 or a location associated with an instance of the activity 242 and the access location 212. The notice module 516 can further use the location unit 420, the first user interface 418, the second user interface 438, or a combination thereof to guide the user. The notice module 516 can generate and communicate the access-route 266 based on the context 244, the activity importance 250, the activity 242, or a combination thereof.

It has been discovered that the resource planning content 262 having the access-route 266 based on the context 244, the activity importance 250, the activity 242, or a combination thereof provides increased driving safety relevant to the circumstances of the user. The resource planning content 262 having the access-route 266 based on the context 244, the activity importance 250, the activity 242, or a combination thereof can recognize scenarios where navigational guidance is likely desired by the user to initiate and communicate the access-route 266 without or with minimal interaction with the user while the user is driving to increase safety.

The notice module 516 can generate the schedule adjustment 268 based on reordering, reorganizing, cancelling, or a combination thereof for the activity 242 having lower value of the activity importance 250 than the future activity estimation 258 or the activity 242 subsequent thereto. The notice module 516 can further generate the schedule adjustment 268 for the activity 242 involving only the user or a select group of people, such as informal or personal contacts. The notice module 516 can further generate the schedule adjustment 268 involving only certain types of the activity 242, such as recreational or the activity 242 not considered a special event.

The notice module 516 can further determine the affirmative response 520 to the resource planning content 262. The notice module 516 can determine the affirmative response 520 in various ways.

For example, the notice module 516 can identify a keyword or a pattern of the contextual parameter 246 describing the user in the communication data 252, the behavioral data 254, or a combination thereof for determining the affirmative response 520. As a more specific example, the notice module 516 can determine the affirmative response 520 when the user communicates to a participant the user's intent to access the optimal access selection 240, when a sequence of the current location 248 indicates a change in direction of travel toward the optimal access selection 240 or traversal of the access-route 266, or a combination thereof.

The response module 518 is configured to adjust the first device 102, the second device 106, or a combination thereof based on the optimal access selection 240, the consumption model 304, the affirmative response 520, the activity 242, the activity importance 250, the context 244, the contextual parameter 246, or a combination thereof. The response module 518 can adjust the device by adjusting a device configuration. For example, the response module 518 can adjust a time-out duration, such as for turning off displays or for shorter or quieter audible output, display output or brightness, suspension of a function or a process, or a combination thereof.

The response module 518 can generate the configuration-adjustment profile 264 of FIG. 2 for adjusting the device configuration. The response module 518 can generate the configuration-adjustment profile 264 in a variety of ways.

For example, the response module 518 can lessen the value for the device configuration for decreasing the intensity, or for stopping or suspending functions or features having the application priority 270 of FIG. 3 less than a threshold or the future activity estimation 258. The threshold can be predetermined by the computing system 100.

The response module 518 can further generate the configuration-adjustment profile 264 based on the affirmative response 520. The response module 518 can estimate an arrival time for the user at the optimal access selection 240, an amount of time or the resource 202 available for access at the optimal access selection 240, or a combination thereof.

The response module 518 can use the estimated information and the consumption model 304 to determine an amount of usage reduction of the resource 202 necessary for accommodating the user for various instances of the activity 242 in view of the user accessing the optimal access selection 240. The response module 518 can generate the configuration-adjustment profile 264 to generate the amount of usage reduction for the resource 202.

It has been discovered that the configuration-adjustment profile 264 based on the affirmative response 520 provides optimal usage of the resource 202 in view of the user's likely access of the optimal access selection 240. The configuration-adjustment profile 264 based on the affirmative response 520 can account for the user's intent to access the optimal access selection 240. The response module can determine an optimal amount of reduction in usage of the resource 202 based on the likely access and adjust the device configuration only enough to achieve the optimal amount of reduction, without unnecessarily limiting the user's access or usage of the first device 102, the second device 106, or a combination thereof.

For illustrative purposes, the various modules have been described as being specific to the first device 102 or the second device 106. However, it is understood that the modules can be distributed differently. For example, the various modules can be implemented in a different device, or the functionalities of the modules can be distributed across multiple devices. Also as an example, the various modules can be stored in a non-transitory memory medium.

For a more specific example, the functions of the usage module 506 and the model generator module 508 can be merged and be specific to the first device 102 or the second device 106. Also for a more specific example, the function for determining the inference set 236 and the access model 302 can be separated into different modules, separated across the first device 102 and the second device 106, or a combination thereof. As a further specific example, one or more modules show in FIG. 5 can be stored in the non-transitory memory medium for distribution to a different system, a different device, a different user, or a combination thereof.

The modules described in this application can be stored in the non-transitory computer readable medium. The first storage unit 414, the second storage unit 446, or a combination thereof can represent the non-transitory computer readable medium. The first storage unit 414, the second storage unit 446, or a combination thereof or a portion thereof can be removable from the first device 102 or the second device 106. Examples of the non-transitory computer readable medium can be a non-volatile memory card or stick, an external hard disk drive, a tape cassette, or an optical disk.

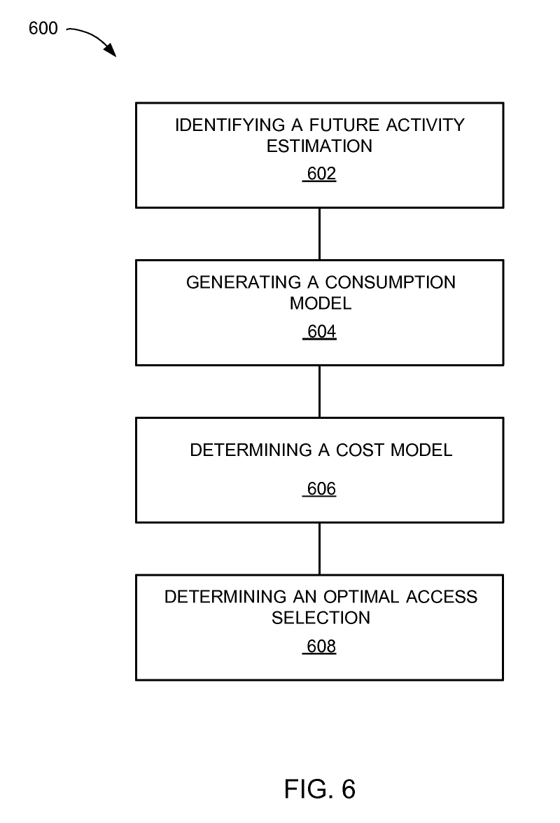

Referring now to FIG. 6, therein is shown a flow chart of a method 600 of operation of a computing system 100 in a further embodiment of the present invention. The method 600 includes: identifying a future activity estimation for representing an activity occurring after a current time in a block 602; generating a consumption model associated with the future activity estimation for describing a resource in a block 604; determining a cost model for evaluating an access location in a block 606; and determining an optimal access selection based on the cost model and the consumption model for displaying on a device in a block 608.

It has been discovered that the cost model 306 of FIG. 3 having the cost-category 308 of FIG. 3 for evaluating the security factor 310 of FIG. 2, the privacy factor 312 of FIG. 2, the efficiency factor 314 of FIG. 2, the cost factor 316 of FIG. 2, or a combination thereof provides a method of evaluating abstract factors having importance to the user. It has also been discovered that the cost model 306 based on the activity 242 of FIG. 2, the context 244 of FIG. 2, the consumption model 304 of FIG. 2, or a combination thereof provides contextually relevant evaluation for the access location 212.

It has further been discovered that optimal access selection 240 of FIG. 2 from the inference set 236 of FIG. 2 provides reliable and trustworthy instance of the access location 212 of FIG. 2. It has been discovered that the optimal access selection 240 based on the cost model 306, including a correspondence between the source attribute 216 of FIG. 2, the access type 214 of FIG. 2, or a combination thereof and the cost-category 308, provides an accurate assessment for comparing instances of the access location 212 of FIG. 2 according to the context 244, the activity 242, or a combination thereof.

The physical transformation from the optimal access selection 240 and the resource planning content 262 results in the movement in the physical world, such as changing a configuration setting on the first device 102 or movement of the user along with the device. Movement in the physical world results in updates to inference set 236, the source attribute 216, the access history 238, the access model 302, the consumption model 304, or a combination thereof, which can be fed back into the computing system 100 and used to further update the optimal access selection 240 and the resource planning content 262.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. A computing system comprising:
an activity-schedule module configured to identify a future activity estimation for representing an activity occurring after a current time;
a usage module, coupled to the activity-schedule module, configured to generate a consumption model associated with the future activity estimation for describing a resource;
a model generator module, coupled to the usage module, configured to determine a cost model for evaluating an access location; and
a selection module, coupled to the model generator module, configured to determine an optimal access selection based on the cost model and the consumption model for displaying on a device.

2. The system as claimed in claim 1 wherein:
the model generator module is configured to determine the cost model including a cost-category; and
the selection module is configured to determine the optimal access selection having a source attribute corresponding to the cost-category.

3. The system as claimed in claim 1 further comprising:
an access-detail module, coupled to the activity-schedule module, configured to determine an inference set for accessing the resource; and
wherein:
the selection module is configured to determine the optimal access selection from the inference set.

4. The system as claimed in claim 1 wherein:
the activity-schedule module includes a context module configured to determine a contextual parameter without using a calendar entry; and
the activity-schedule module is configured to identify the future activity estimation based on the contextual parameter.

5. The system as claimed in claim 1 wherein:
the activity-schedule module includes a context module configured to determine a future context associated with the future activity estimation for identifying the resource; and
the selection module is configured to determine the optimal access selection for providing the resource.

6. The system as claimed in claim 1 wherein:
the activity-schedule module includes a context module configured to determine a future context associated with the future activity estimation; and
further comprising:
a notice module, coupled to the selection module, configured to generate a resource planning content based on the future context for managing the resource for displaying on the device.

7. The system as claimed in claim 6 wherein the notice module is configured to generate a schedule adjustment for accessing the resource based on the future activity estimation.

8. The system as claimed in claim 6 wherein the notice module is configured to generate an access-route for accessing the resource based on the future activity estimation.

9. The system as claimed in claim 6 further comprising:
an access-detail module, coupled to the activity-schedule module, configured to generate an access model for representing the resource for using the device; and
wherein:
the notice module is configured to generate the resource planning content based on the future activity estimation and the access model.

10. The system as claimed in claim 6 wherein:
the notice module is configured to determine an affirmative response to the resource planning content; and
further comprising:
a response module, coupled to the notice module, configured to generate a configuration-adjustment profile based on the affirmative response for using the device.

11. A method of operation of a computing system comprising:
identifying a future activity estimation for representing an activity occurring after a current time;
generating a consumption model associated with the future activity estimation for describing a resource;
determining a cost model for evaluating an access location; and
determining an optimal access selection based on the cost model and the consumption model for displaying on a device.

12. The method as claimed in claim 11 wherein:
determining the cost model includes determining the cost model including a cost-category; and
determining the optimal access selection includes determining the optimal access selection having a source attribute corresponding to the cost-category.

13. The method as claimed in claim 11 further comprising:
determining an inference set for accessing the resource; and
wherein:
determining the optimal access selection includes determining the optimal access selection from the inference set.

14. The method as claimed in claim 11 further comprising:
determining a contextual parameter without using a calendar entry; and
wherein:
identifying the future activity estimation includes identifying the future activity estimation based on the contextual parameter.

15. The method as claimed in claim 11 further comprising:
determining a future context associated with the future activity estimation for identifying the resource;
wherein:
determining the optimal access selection includes determining the optimal access selection for providing the resource.

16. A non-transitory computer readable medium including instructions comprising:
identifying a future activity estimation for representing an activity occurring after a current time;
generating a consumption model associated with the future activity estimation for describing a resource;
determining a cost model for evaluating an access location; and
determining an optimal access selection based on the cost model and the consumption model for displaying on a device.

17. The non-transitory computer readable medium as claimed in claim 16 wherein:
determining the cost model includes determining the cost model including a cost-category; and
determining the optimal access selection includes determining the optimal access selection having a source attribute corresponding to the cost-category.

18. The non-transitory computer readable medium as claimed in claim 16 further comprising:
determining an inference set for accessing the resource; and
wherein:
determining the optimal access selection includes determining the optimal access selection from the inference set.

19. The non-transitory computer readable medium as claimed in claim 16 further comprising:
determining a contextual parameter without using a calendar entry; and
wherein:
identifying the future activity estimation includes identifying the future activity estimation based on the contextual parameter.

20. The non-transitory computer readable medium as claimed in claim 16 further comprising:
determining a future context associated with the future activity estimation for identifying the resource;
wherein:
determining the optimal access selection includes determining the optimal access selection for providing the resource.
